(19) United States
(12) Patent Application Publication
(10) Pub. No.: US 2023/0001944 A1
(43) Pub. Date: Jan. 5, 2023

(54) VEHICLE SAFETY SYSTEM AND A METHOD OF ACCESSING A VEHICLE

(71) Applicant: ROCKNE INVESTMENTS, LLC, Red Rock, TX (US)

(72) Inventor: Kevin Goertz, Red Rock, TX (US)

(21) Appl. No.: 17/841,417

(22) Filed: Jun. 15, 2022

Related U.S. Application Data
(60) Provisional application No. 63/210,894, filed on Jun. 15, 2021.

(51) Int. Cl. B60W 50/14; B60W 40/08; G06V 20/59

(52) U.S. Cl. CPC B60W 50/14; B60W 40/08; G06V 20/597; B60W 2050/143

(57) ABSTRACT

Vehicle safety system that ensures user of a vehicle performs a 360-degree walk around of the vehicle before it is moved from a resting location. Vehicle safety system includes plurality of input receivers positioned around the vehicle, and a pressure switch at the driver's seat of the vehicle, motion sensor, or the like to detect presence of an operator in the driver's seat of the vehicle. The user walks around the vehicle and activates the input receivers within a predetermined time period before sitting in the driver's seat. If user fails to activate input receivers, then the vehicle safety system generates an alert or alarm. This ensures the user completes a 360-degree walk around before sitting in the vehicle. If user activates the input receivers within the predetermined time period, then the vehicle safety system deactivates the alarm, allowing operator to sit in their seat without the alert being triggered.

The present application claims the benefit of U.S. Provisional Application No. 63/210,894, filed Jun. 15, 2021; all of which is incorporated herein by reference.

### FIELD OF INVENTION

The present subject matter generally relates to vehicle safety systems. More specifically, the present subject matter relates to a vehicle safety system facilitating access to a user to operate the vehicle after he walks around the vehicle and clears any obstruction before starting the vehicle.

### BACKGROUND OF INVENTION

It is known that keyless entry systems have long been employed in vehicles to permit vehicle doors to be unlocked without requiring the user to insert a key into a keyhole provided at an entry handle on the vehicle door. Typically, the keyless entry systems are used to remotely lock, unlock and start an engine of the vehicle using radiofrequency (RF) signals.

Several keyless entry systems have been disclosed in the past to control access to the vehicles. One such example is disclosed in a U.S. Pat. No. 10,414,377, entitled, “System and method for facilitating user access to vehicles based on biometric information” (“the '377 patent”). The '377 patent discloses systems and methods provided for authorizing a user to access an access-controlled environment. The system includes a system server platform that communicates with mobile devices (e.g., smartphones) and on-board vehicle computing devices accessed by users. The embodiments enable a series of operations whereby a user accessing a vehicle is prompted to biometrically authenticate using the user's smartphone or on-board vehicle computer. In addition, the system can further authorize the user and electronically facilitate access to the vehicle as well as perform other authorized operations relating to the use of the vehicle. In addition, the vehicle access system integrates with various computing devices and computer-based services accessible to the user. The systems and methods also facilitate active monitoring of the vehicle occupants and environmental conditions using optical sensors and the like so as to enhance security, convenience and safety of the occupants during use of the vehicle.

Another example is disclosed in a United States Published Application No. 20170018129, entitled “Vehicle Entry Keypad with Battery Charge Indicator” (“the '129 Publication”). The '129 Publication discloses a keypad mounted on the exterior of an electric vehicle, for example on the B-pillar, and is used to enter a code to enable unlocking and entry into the vehicle. The keypad is further operative to provide an indication of the state-of-charge of the battery of the vehicle. The keypad is made up of a series of active (for example, touch-sensitive) regions which illuminate when touched to enter the code. Each active region may illuminate selectively and individually to represent a predetermined percentage of battery charge, so that the total number of active regions illuminated corresponds to the state-of-charge of the battery.

Another example is disclosed in a U.S. Pat. No. 9,499,129, entitled “Methods and systems for using cloud services to assign e-keys to access vehicles” (“the '129 patent”). The '129 patent discloses a method for providing access to a vehicle. The method includes sending, by a server, an access code for the vehicle to a portable device. The access code is configured to be transferred by the portable device to the vehicle. Then, receiving, by the server, data from the portable device that is indicative that the portable device is located outside of the vehicle or proximate thereto. Sending, by the server, validation to the vehicle that the access code received by the vehicle was sent to the portable device, and then the vehicle is configured to send an electronic key to the portable device upon receiving the validation. The electronic key is associated with at least one privilege associated with use of the vehicle, and the at least one privilege is defined based on the access code.

Although the above-discussed disclosures provide different methods of accessing the vehicle, they do not provide any information to the user regarding any obstruction around the vehicle that could cause an unintentional property damage or personal injury.

Therefore, there is a need in the art to provide a vehicle safety system that provides access to the user to operate the vehicle after he walks around the vehicle and clears any obstruction before starting the vehicle.

### SUMMARY

It is an object of the present subject matter to provide an improved vehicle safety system and that avoids the drawback of known techniques.

It is another object of the present subject matter to provide a vehicle safety system to ensure there is no obstruction around the vehicle before starting the vehicle to reduce likelihood of an unintentional property damage or personal injury.

In order to achieve one or more objects, the present subject matter provides a vehicle safety system or a walk around alerting system that ensures a user of a vehicle performs a 360-degree walk around of the vehicle before it is moved from a resting location. The vehicle safety system includes a plurality of input receivers positioned around the vehicle. In one example, the input receivers position at four corners of the vehicle. In another example, the input receivers position at different locations or configure as a continuous line around the vehicle. The input receivers include pads, buttons, proximity sensors, optical sensors, communication ports and the like. Further, the vehicle safety system includes a pressure switch, optical sensor, motion detector, or the like at the driver's seat of the vehicle detecting an operators presence.

In accordance with the present invention, the user walks around the vehicle and activates the input receivers within a predetermined time period, say one minute before sitting in the driver's seat. If the user fails to activate the input receivers located about the perimeter of the vehicle within the predetermined time period before sitting in the driver's seat, then the vehicle safety system generates an alert or alarm. This ensures the user completes a 360-degree walk around before sitting in the vehicle.

If the user activates the input receivers within the predetermined time period, then the vehicle safety system deactivates the alarm for a period say one minute starting from the time (predetermined time period) any of the input receiver was engaged first, allowing the operator to sit in the vehicle's seat without the alert being triggered. Here, the alarm stays deactivated until the user vacates the seat for more than 15 seconds (or predetermined time period), at which time the vehicle safety system resets, requiring a subsequent walk around. This ensures the user completes a 360-degree walk around before sitting in the vehicle.

In one implementation, the vehicle safety system includes an additional sensor (or sensors) that detects if there are any obstructions around the vehicle, say at the front and/or rear of the vehicle. In this implementation, once the alarm is deactivated by the user after performing the walk around, engaging all input receivers around the vehicle, then sitting in the driver's seat; this generates an additional alert when an obstruction is detected by the motion detector placed on the vehicle at the front and/or rear of the vehicle. This allows the vehicle safety system to operate without the input receivers.

In one advantageous feature of the present subject matter, the vehicle safety system ensures the user of the automobile walks around the vehicle and activates the input receivers. By virtue of his activating the input receivers, the user clears obstruction around the vehicle and uses the vehicle. Further, this ensures the user walks around the vehicle and clears any obstruction before starting the vehicle. This reduces the likelihood of unintentional property damage or personal injury by the user driving the vehicle.

In one advantageous feature of the present subject matter, the vehicle safety system can be used as a means to authenticate the user to access the vehicle as the input receivers act as a level of security which the user has to activate/clear to access the vehicle.

Features and advantages of the subject matter hereof will become more apparent in light of the following detailed description of selected embodiments, as illustrated in the accompanying FIGUREs. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates an environment in which a vehicle safety system implements in a vehicle, in accordance with one embodiment of the present subject matter;

FIG. 2 illustrates a block diagram of the vehicle safety system;

FIGS. 3 and 4 show a circuitry and a method of operating the circuitry, in accordance with one exemplary embodiment of the present subject matter;

FIG. 5 illustrates a method of ensuring a user of a vehicle performs a 360-degree walk around of the vehicle before it is moved from a resting location;

FIG. 6 illustrates a method of ensuring a user of a vehicle performs a 360-degree walk around of the vehicle before occupying driver's seat; and

FIG. 7 illustrates an environment in which a vehicle safety system implements in a vehicle, in accordance with another embodiment of the subject matter.

It will be noted that throughout the appended drawings, like features are identified by like reference numerals.

### DETAILED DESCRIPTION OF THE EMBODIMENTS

Before the present features and working principle of a vehicle safety system is described, it is to be understood that this subject matter is not limited to the particular system as described, since it may vary within the specification indicated. Various features of a vehicle safety system might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present subject matter describes a vehicle safety system that ensures a user of a vehicle performs a 360-degree walk around of the vehicle before it is moved from a resting location. The vehicle safety system includes a plurality of input receivers positioned around the vehicle. The vehicle safety system includes a pressure switch, optical sensor, motion detector, or the like at the driver's seat of the vehicle. The user walks around the vehicle and touches, scans, or otherwise activates the input receivers within a predetermined time period before sitting in the driver's seat. If the user fails to activate the input receivers, then the vehicle safety system generates an alert or alarm. This ensures the user completes a 360-degree walk around before sitting in the vehicle. If the user activates the input receivers within the predetermined time period, then the vehicle safety system deactivates the alarm, allowing the operator to sit in their seat without the alert being triggered.

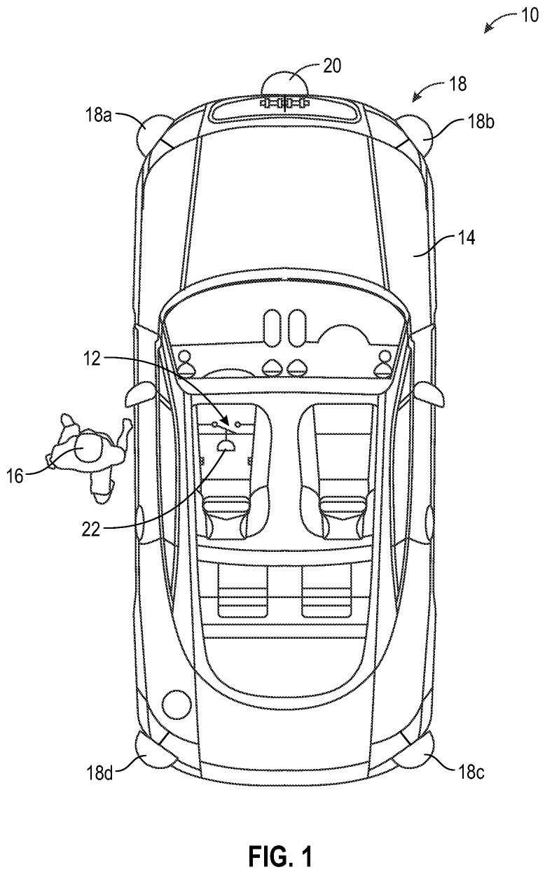

Various features and embodiments of a vehicle safety system that ensures a user of a vehicle performs a 360-degree walk around of the vehicle before it is moved from a resting location are explained in conjunction with the description of FIGS. 1-7.

The present subject matter discloses a vehicle safety system that ensures a user of a vehicle performs a 360-degree walk around of the vehicle before it is moved from a resting location. FIG. 1 shows a top view of environment 10 in which vehicle safety system 12 implements in vehicle 14, in accordance with one embodiment of the present subject matter. Here, vehicle 14 includes a motorcycle, car, truck, boat, train or any other vehicle. In the present embodiment, user 16 activates vehicle safety system 12 by pressing or touching plurality of input receivers 18 placed around vehicle 14. Plurality of input receivers 18 include first input receiver 18a, second input receiver 18b, third input receiver 18c, and fourth input receiver 18d, collectively referred as input receivers 18 or simply input receiver 18 when referred to a single input receiver. Input receivers 18 position around vehicle 14 at equal or varied distance from one another. Input receivers 18 provide material made of hard or soft material including, but not limited to, metal, plastic, synthetic or any other similar material. Input receivers 18 come in a variety shapes and sizes depending on the need. In one example, input receivers 18 position around vehicle 14 in full or partially (e.g., at a distance of one foot or one meter apart). In another example, input receivers 18 position at the corners of vehicle 14 as shown in FIG. 1. In another example, input receivers 18 position only at the driver side of vehicle 14. From the above, a person skilled in the art understands that input receivers 18 position in a variety of configurations including, but not limited to, straight, vertical, horizontal, curved, zigzag or any other configuration depending on the need.

Vehicle safety system 12 includes motion sensor 20. Motion sensor 20 configures to detect movement of user 16 and transmits the data for further processing. In one implementation, vehicle safety system 12 includes pressure switch 22 (or motion sensor, or the like) that mounts at a steering wheel or driver seat of vehicle 14.

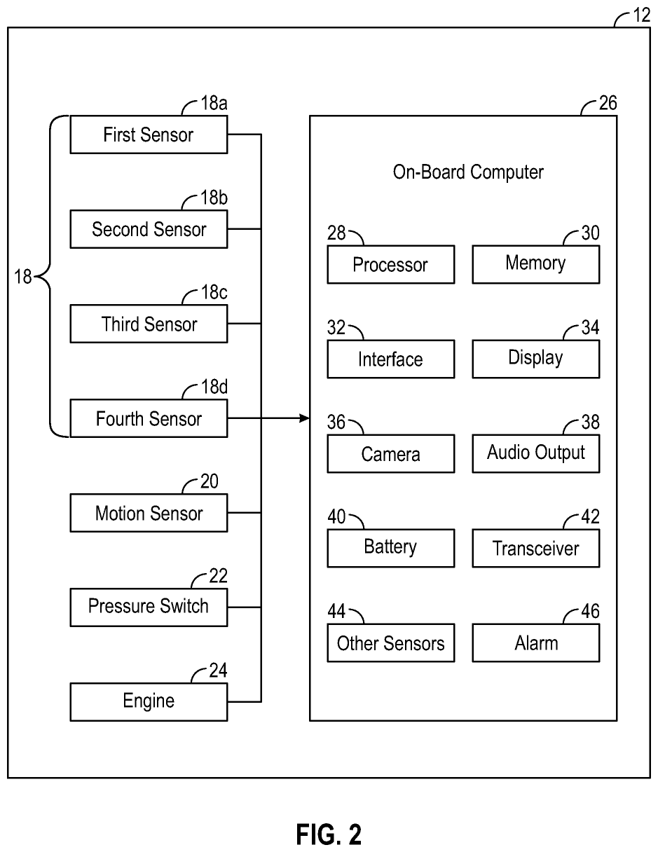

FIG. 2 shows a block diagram of vehicle safety system 12, in accordance with one embodiment of the present subject matter. As can be seen, vehicle safety system 12 includes input receivers 18. Each input receiver 18 includes a pad, a button, a key hole, a proximity sensor, an optical sensor, a communication port and the like. Each input receiver 18 includes a capacitive sensor configured to sense contact or close proximity (e.g., 1 millimetre or centimetre) of the user's finger with input receiver 18 and defines a binary switch output (ON or OFF) indicating user's selection of corresponding input receiver. For example, when user 16 presses any one input receiver 18, user's finger enters a capacitive sense activation field. Subsequently, input receiver 18 detects a disturbance caused by the finger to the activation field and determines whether the disturbance is sufficient to generate an input with the corresponding input receiver 18. The disturbance detected is processed using the charge pulse signal associated with the corresponding signal channel for that input receiver 18. Here, each input receiver 18 configures to have their own dedicated signal channel generating a distinct charge pulse signal for identifying the disturbance corresponding to the user's finger press. Upon detecting the disturbance of the activation field, the corresponding input receiver 18 sends a signal to processor 26 for processing the signal.

Vehicle safety system 12 presents an engine 24 that powers vehicle 14. Assuming that vehicle 14 is an electric vehicle, then an electric motor or electric powertrain replaces engine 24.

Vehicle safety system 12 includes on-board computer 26. On-board computer 26 controls the operation of vehicle safety system 12 to ensure a 360-degree walk around of vehicle 14 has been performed, and/or provide secure access to user 16 for operating vehicle 14. In one implementation, on-board computer 26 includes a dashboard that mounts in front of the driver seat of vehicle 14. In another example, on-board computer 26 comes as a stand-alone component and integrates with the vehicle's dashboard. This allows vehicle safety system 12 to retro-fit in an old vehicle to provide secure access to use vehicle 14. On-board computer 26 electrically connects to input receivers 18, motion sensor 20 and pressure switch 22 and engine 24 (FIG. 2).

On-board computer 26 includes processor 28. Processor 28 includes one or more commonly known Central Processing Unit (CPU) such as a microprocessor or microcontroller. It should be understood that processor 28 is responsible for implementing specific functions under the control of software including an operating system, and any appropriate applications software.

On-board computer 26 includes memory 30 such as a volatile memory (e.g., RAM), non-volatile memory (e.g., disk memory, FLASH memory, EPROMs, etc.), unalterable memory, and/or other types of memory. In one implementation, memory 30 stores data, program instructions. The program instructions might control the operation of an operating system and/or one or more applications.

On-board computer 26 includes interface(s) 32. Interface 32 includes wired interfaces and/or wireless interfaces. In at least one implementation, interface(s) 32 includes functionality similar to at least a portion of functionality implemented by one or more computer system interfaces such as those described herein and/or generally known to one having ordinary skill in the art.

On-board computer 26 may include display(s) 34. Display(s) 34 implements using LCD display technology, OLED display technology, and/or other types of conventional display technology.

On-board computer 26 may include camera 36 either inside or outside of vehicle 14. In one example, camera 36 positions at the roof or windshield of vehicle 14 and captures user 16 sitting in the driver seat. In another example, camera 36 positions at the outer side of vehicle 14 and captures images or video of user 16 or others walking around vehicle 14.

On-board computer 26 may include audio output 38. Audio output 38 indicates a speaker 38 that receives the audio decoded by an Audio/Video unit(s) (not shown) and announces/provides alarms and/or voice instructions to user 16 of vehicle 14.

On-board computer 26 includes battery 40 specifically configured to power on-board computer 26. Alternatively, battery 40 includes a main battery that supplies power to one or more components of vehicle 14.

On-board computer 26 may include wireless communication module/transceiver 42. Transceiver 42 configures to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

On-board computer 26 includes other sensors 44 such as proximity sensors, optical sensors, temperatures sensors, and the like, or a combination thereof. Other sensors 44 either as standalone sensors in conjunction with motion sensor 20.

On-board computer 26 includes alarm 46. Alarm 46 operates as a standalone speaker or operates in conjunction with audio output 38 to generate an alert to user 16.

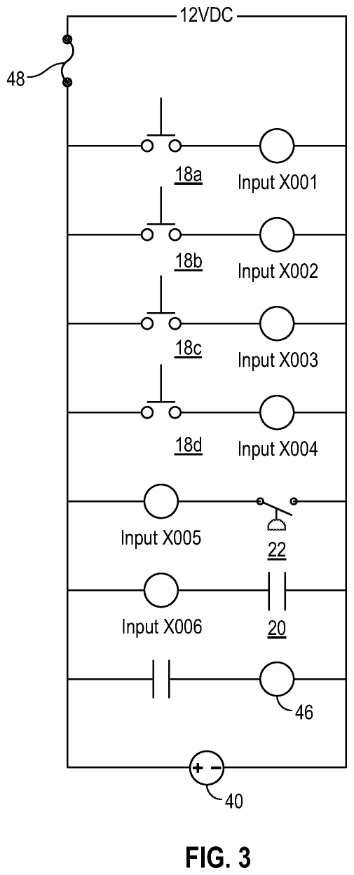

FIG. 3 shows a circuitry that enables vehicle safety system 12 to provide access to user 16 for operating vehicle 14 after he walks around vehicle 14. The circuitry includes at least input receivers 18, motion sensor 20, pressure switch 22 and alarm 44. Here, input receivers 18 such as first input receiver 18a, second input receiver 18b, third input receiver 18c, and fourth input receiver 18d connect (fuse 48) in a parallel to pressure switch 22. Further, motion sensor 20 connects to pressure switch 22. Pressure switch 22 further connects to alarm 46. In one implementation, each of input receivers 18, motion sensor 20, pressure switch 22 and alarm 46 draw power from battery 40.

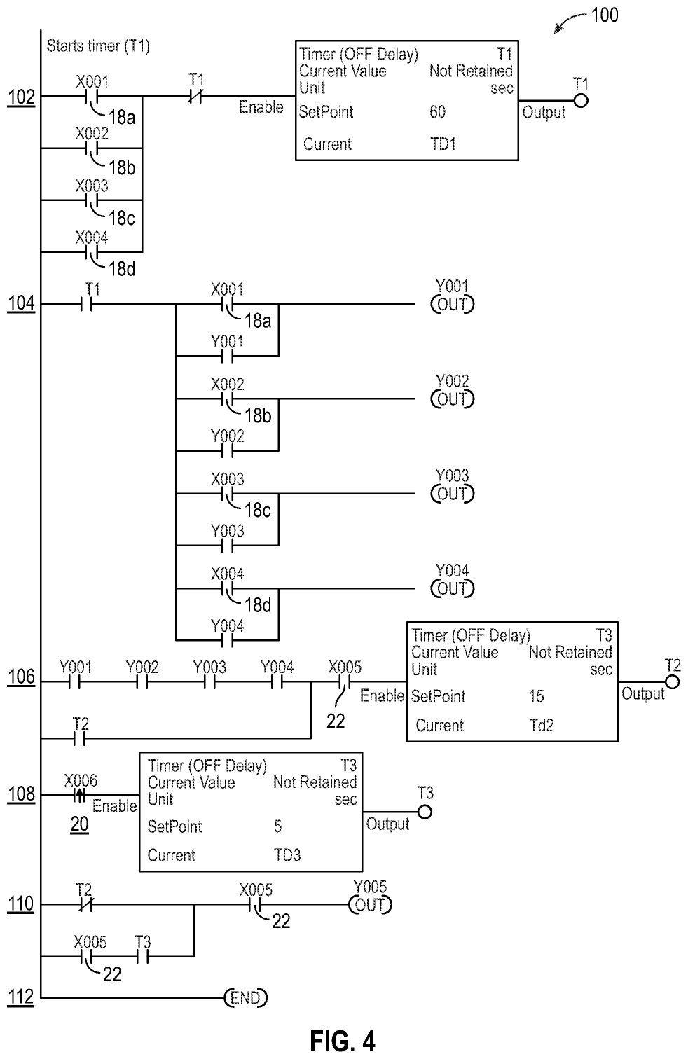

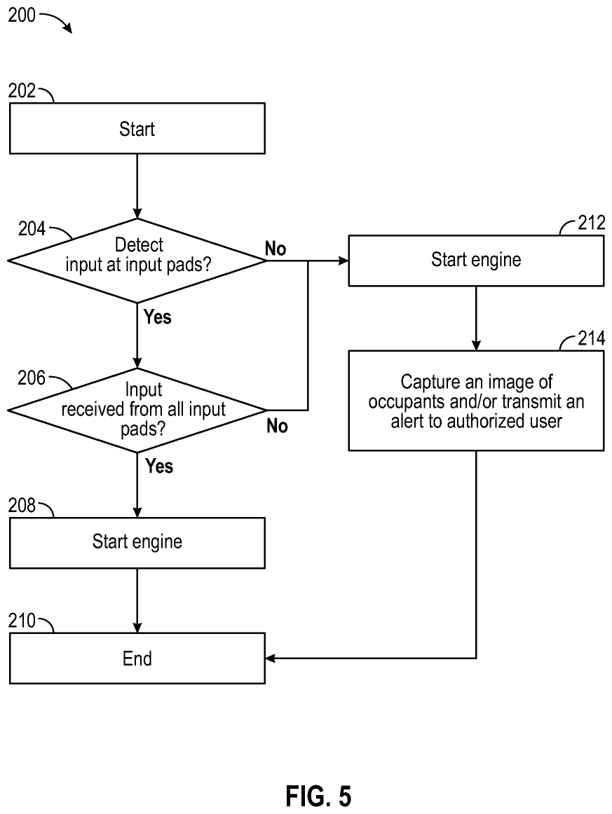

In accordance with one embodiment of the present subject matter, the circuitry (FIG. 3) configures to detect activation of each of first input receiver 18a, second input receiver 18b, third input receiver 18c, and fourth input receiver 18d, detect movement of user 16 by motion sensor 20 and activation of pressure switch 22 by user 16 to provide access to user 16 for operating vehicle 14. FIG. 4 shows method 100 of operating the circuitry. Here, the circuitry helps to provide access to vehicle 14 when user 16 walks around vehicle 14 and presses first input receiver 18a, second input receiver 18b, third input receiver 18c, and fourth input receiver 18d followed by activating pressure switch 22 at the driver's seat. Further, the circuitry triggers an alarm when user 16 does not activate or press first input receiver 18a, second input receiver 18b, third input receiver 18c, and fourth input receiver 18d without completely moving around vehicle 14 and activates pressure switch 22 indicating he did not walk around vehicle 14. FIG. 5 displays method 200 which determines whether user 16 has pressed all input receivers 18 and activated pressure switch 22 within a predetermined time in order to ensure he completed walking around vehicle 14 so that vehicle safety system 12 can provide access to operate vehicle 14.

At step 102, timer (T1) is set for a predetermined time period say one (1) minute to press all input receivers 18 and activate pressure switch 22. In one example, the circuitry configures to receive input from user 16 on any of input receivers 18. In other words, user 16 can press first input receiver 18a, second input receiver 18b, third input receiver 18c, and fourth input receiver 18d in any order (but must press all input receivers 18). Alternatively, the circuitry configures to receive input in a series say in clockwise or anti-clockwise direction from user 16 on input receivers 18. For example, the circuitry configures to receive input in clockwise direction in the order first input receiver 18a, second input receiver 18b, third input receiver 18c and fourth input receiver 18d. Only when user 16 presses first input receiver 18a, second input receiver 18b, third input receiver 18c and fourth input receiver 18d in the order, the circuitry considers that activation of input receivers 18 is completed. Here, the circuitry holds each of first input receiver 18a, second input receiver 18b, third input receiver 18c and fourth input receiver 18d active when any of input receivers 18 is pressed as long as timer (T1) is active (step 104).

If user 16 presses or scans all input receivers 18 and activates pressure switch 22 within one minute (or predetermined time), then the circuitry disables alarm 44 for a period of one minute (or predetermined time) starting from the time any of input receivers 18 is activated. This allows user 16 to sit in the vehicle seat without alarm 44 being triggered. Here, the circuitry ensures that alarm 44 is deactivated until user 16 vacates the vehicle seat for more than 15 seconds (or predetermined time) at which the circuitry resets requiring user 16 to walk around again (subsequently), as shown at step 106. The circuitry may continuously receive input from motion sensor 20 determining movement of user 16 around vehicle 14 (step 108) for pressing input receivers 18 and then entering vehicle 14 for activating pressure switch 22. Here, the circuitry activates alarm 44 if pressure switch 22 is activated after being deactivated for 15 seconds. Further, the circuitry raises alarm 44 when both motion sensor 22 and pressure switch 22 are activated simultaneously (step 110). The method 100 ends at step 112.

Optionally, the circuitry includes an additional sensor that detects if there is any obstruction at the front and/or rear of vehicle 14. In this embodiment, once alarm 44 is deactivated after user 16 has performed the walk around, engaging all input receivers 18 around vehicle 14, then sitting in the driver's seat; then the additional sensor detects any obstruction at the front or rear of vehicle 14 and allows it to trigger an alert. Here, vehicle safety system 12 operates without motion sensor 20.

FIG. 5 shows a method 200 of accessing vehicle 12, in accordance with further embodiment of the present subject matter. The method 200 may be described in the general context of computer executable instructions. Generally, computer executable instructions may include routines, programs, objects, components, data structures, procedures, modules, functions, etc., that perform particular functions or implement particular abstract data types. The method 200 may also be practiced in a distributed computing environment where functions are performed by remote processing devices that are linked through a communications network. In a distributed computing environment, computer executable instructions may be located in both local and remote computer storage media, including memory storage devices.

The order in which the method 200 is described and is not intended to be construed as a limitation, and any number of the described method blocks can be combined in any order to implement the method 200 or alternate methods. Additionally, blocks may be deleted from the method 200 without departing from the spirit and scope of the subject matter described herein. Furthermore, the method may be implemented in any suitable hardware, software, firmware, or combination thereof. However, for ease of explanation, in the embodiments described below, the method 200 may be implemented in the above-described vehicle safety system 12.

As specified above, vehicle safety system 12 incorporates a circuitry that detects user activating input receivers and activates an alarm if input receivers 18 are not activated followed by activation of pressure switch 22. In the present embodiment, vehicle safety system 12 checks whether all inputs 18 have been activated before starting engine 24 of vehicle 14 to provide access to user 16. Method 100 starts at step 202. At step 204, vehicle safety system 12 checks whether input receivers 18 received user's input within the predetermined time period. If all input receivers 18 receive (step 206) the input, then vehicle safety system 12 checks whether engine 24 has been started (step 208). If engine 24 starts after all input receivers 18 have been pressed, then method 200 ends at step 210 and no further action is taken.

If vehicle safety system 12 detects that engine 24 has been started (step 212) without detecting any input from input receivers 18 at step 204 or if all input receivers 18 have not been pressed (at step 206), then vehicle safety system 12 employs alarm 46 to alert people nearby vehicle 14 as explained above. Further, vehicle safety system 12 employs camera 36 to capture an image of occupants and transmits to authorised user or owner via transceiver 42 (step 214) to take further action. Method 200 ends at step 210.

Although the above embodiments have been explained considering that user 16 presses input receivers 18 placed around vehicle 14, it is obvious to provide other means such as optical sensors, contactless mechanisms in place of input receivers 18 to detect movement of user 16.

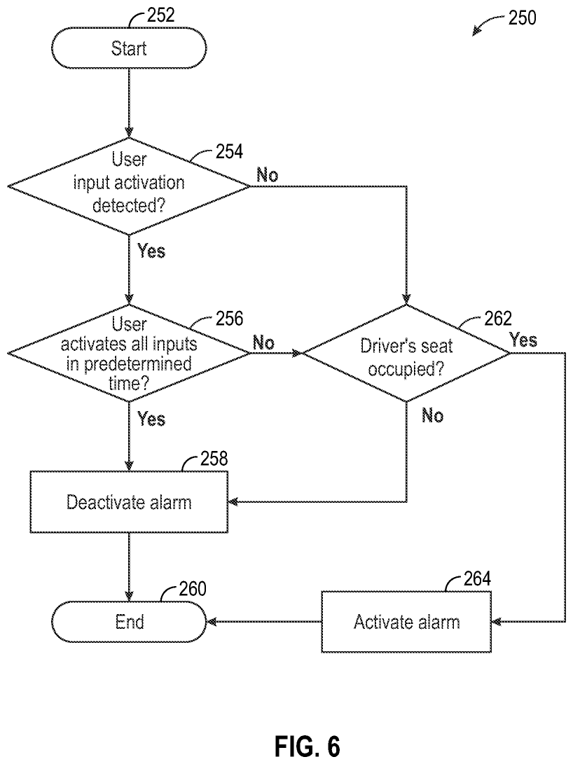

FIG. 6 illustrates a method 250 of ensuring user 16 of vehicle 14 performs a 360-degree walk around of vehicle 14 before occupying driver's seat, in accordance with one embodiment of the present subject matter. The order in which method 250 is described and is not intended to be construed as a limitation, and any number of the described method blocks can be combined in any order to implement method 250 or alternate methods. Additionally, blocks may be deleted from method 250 without departing from the spirit and scope of the subject matter described herein. Furthermore, the method may be implemented in any suitable hardware, software, firmware, or combination thereof. However, for ease of explanation, in the embodiments described below, the method 250 may be implemented in the above-described vehicle safety system 12.

Method 250 starts at step 252. At step 254, vehicle safety system 12 detects whether user's input has been received by way of activating each of input receivers 18. Here, user 16 performs a 360-degree walk around of vehicle 14 and activates input receivers 18 placed around vehicle 14. At step 256, vehicle safety system 12 detects whether all input receivers 18 have been activated within a predetermined time, say 15 seconds. If all input receivers 18 have been activated within the predetermined time, then method 250 moves to step 258. At step 258, vehicle safety system 12 deactivates alarm 46. Further, method 250 moves to step 260 and ends.

If vehicle safety system 12 does not detect activation of input receivers 18 at step 254 or does not receive activation of input receivers 18 within the predetermined time at step 256, then method 250 moves to step 262. At step 262, vehicle safety system 12 checks whether the driver's seat is occupied without activation of input receivers 18. If vehicle safety system 12 determines that vehicle seat is not occupied, then method 250 moves to step 258 where vehicle safety system 12 deactivates alarm 46. If vehicle safety system 12 determines that vehicle seat is occupied without activation of input receivers 18 at step 262, then method 250 moves to step 264. At step 264, vehicle safety system 12 activates alarm 46. Further, method 250 moves to step 260 and ends.

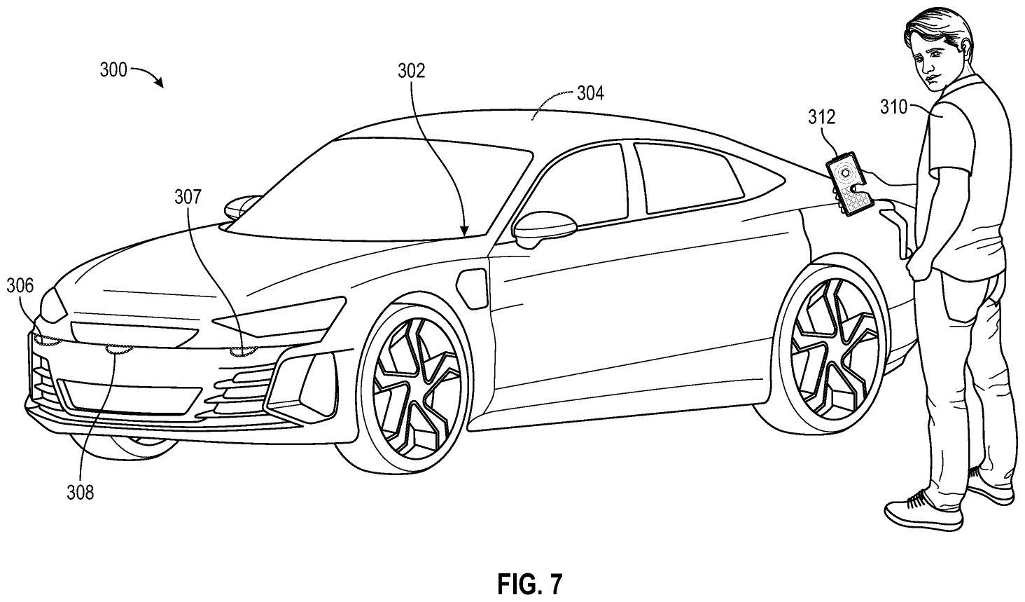

FIG. 7 shows an exemplary environment 300 of vehicle safety system 302 implemented in vehicle 304. Here, vehicle 304 includes input receivers 306, 307. Input receivers 306, 307 position around vehicle 304 at various locations in different configurations. Here, input receivers 306, 307 include optical sensors, proximity sensors, near field communication (NFC) points, scanners or combination thereof for detecting movement of user 312. Optionally, vehicle 304 includes motion detector 308. In the present embodiment, user 310 carries electronic device 312 such as a mobile phone, a tablet, a wrist watch, laptop and the like and walks around vehicle 304 without touching anything. Input receivers 306 detect movement of user 310 and transmit signals to vehicle safety system 302. Vehicle safety system 302 includes a circuitry that detects activation of all input receivers 306, 307 followed by activation of a pressure switch or start of an engine, as explained above.

The methods and diagrams outlined in this patent serve as a basic method as to which this system may function. This intent of this patent is to provide a method and encompass the methodology that an individual shall perform a full observational walk around of a vehicle prior to operation of said vehicle. Actual installation may vary significantly at customers preference of wired versus wireless sensors, alarming/alerting devices, logical setup, and/or level of tamper proofing required by each customer as well as vehicle manufacturer.

From the above, it is evident that the presently disclosed vehicle safety system ensures the user of the vehicle walks around the vehicle and touches the input receivers before the vehicle is moved from a resting location. By virtue of his activating the input receivers, the user ensures there is no obstruction around before starting the vehicle and then uses the vehicle. This reduces the likelihood of an unintentional property damage or personal injury by the user driving the vehicle.

The present subject matter has been described in particular detail with respect to various possible embodiments, and those of skill in the art will appreciate that the subject matter may be practiced in other embodiments. First, the particular naming of the components, capitalization of terms, the attributes, data structures, or any other programming or structural aspect is not mandatory or significant, and the mechanisms that implement the subject matter or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present subject matter include process steps and instructions described herein in the form of an algorithm. It should be noted that the process steps and instructions of the present subject matter could be embodied in software, firmware, or hardware, and when embodied in software, could be downloaded to reside on and be operated from different platforms used by real-time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. Also, the present subject matter is not described with reference to any particular programming language. It is appreciated that a variety of programming languages may be used to implement the teachings of the present subject matter as described herein, and any references to specific languages are provided for disclosure of enablement and best mode of the present subject matter.

It should be understood that components shown in FIGUREs are provided for illustrative purposes only and should not be construed in a limited sense. A person skilled in the art will appreciate alternate components that may be used to implement the embodiments of the present subject matter and such implementations will be within the scope of the present subject matter.

While preferred embodiments have been described above and illustrated in the accompanying drawings, it will be evident to those skilled in the art that modifications may be made without departing from this subject matter. Such modifications are considered as possible variants included in the scope of the subject matter.

We claim:

1. A vehicle safety system facilitating access to a user to operate the vehicle after he walks around the vehicle and clears any obstruction before starting the vehicle, as disclosed and described in the above specification.
